(19) United States
(12) Patent Application Publication
(10) Pub. No.: US 2025/0335328 A1
(43) Pub. Date: Oct. 30, 2025

(54) TELEMETRY MANAGEMENT IN ROUTING ARCHITECTURES

(71) Applicant: Openchip & Software Technologies S.L., Barcelona (ES)

(72) Inventors: Francesc Guim Bernat, Barcelona (ES); Violante Moschiano, Avezzano (IT); Edgar Gonzalez Pellicer, Girona (ES); Gaspar Mora Porta, Castellon de la Plana (ES); Tommaso Vali, Sezze (LT) (IT); Satoru Tagaya, Barcelona (ES); Erich Ludwig Focht, Stuttgart (DE); Massimiliano FRULIO, Milano (IT)

(21) Appl. No.: 19/263,987

(22) Filed: Jul. 9, 2025

Related U.S. Application Data
(63) Continuation of application No. PCT/EP2025/059019, filed on Apr. 2, 2025.

(51) Int. Cl. G06F 11/34; G06F 11/30

(52) U.S. Cl. CPC G06F 11/3466; G06F 11/3089

(57) ABSTRACT

Aspects of telemetry monitoring are described. Compute circuitry in a system includes hardware resources configured to perform compute operations. Telemetry management circuitry in the system is configured to detect a communication flow for an application function. The application function is associated with an application executing on at least one of the hardware resources. The telemetry management circuitry is configured to retrieve a telemetry configuration based on the communication flow. The telemetry configuration identifies at least one metric. The telemetry management circuitry is configured to execute a trace on the at least one metric to obtain metrics results. The telemetry management circuitry is configured to perform a telemetry action based on the metrics results.

### PRIORITY

This application is a continuation of International Application No. PCT/EP2025/059019, filed Apr. 2, 2025, which is incorporated herein by reference in its entirety.

### STATEMENT OF FUNDING

This invention was made with government support under Grant UNICO-IPCEI-2023-001 funded by the European Union-Next Generation EU, Important Projects of Common European Interest (IPCEI).

### BACKGROUND

Current computing systems are often composed of large deployments of different hardware arrangements of different sizes (e.g., hardware in a 1U rack unit, half a rack, or multiple racks) that potentially host different types of platforms and computing technologies (e.g., different processor models, different accelerators, different routing architectures, etc.). Additionally, a large number of software applications and uses (e.g., databases, video analytics, content delivery, etc.) are being developed by different companies that exhibit different behaviors and utilize the resources in different ways. For example, some software applications may be more I/O centric, other software applications may be compute-centric, and even different types of workloads with the same software applications may have different effects on the processing hardware. This presents a significant challenge for system telemetry, including mechanisms to monitor and validate potential service-level agreements (SLAs) associated with the provided functions.

Telemetry generally refers to processes for monitoring, collecting, transmitting, and analyzing data from different sources of a computing system. The analysis of this data can be used to gain insights related to system performance and operational health and used to trigger various responses. The data that is collected from telemetry operations is often referred to as “telemetry data” or simply “telemetry.” However, configuring telemetry to monitor real-time operation flows from different service chains effectively can be challenging.

### BRIEF DESCRIPTION OF THE DRAWINGS

In the drawings, which are not necessarily drawn to scale, reference numerals are repeated to describe similar components in different views. Like numerals having different letter suffixes may represent different instances of similar components. The drawings illustrate generally, by way of example, but not by way of limitation, various embodiments discussed in the present document.

FIG. 1 depicts a chiplet system implementing telemetry management, according to an embodiment.

FIG. 2 depicts telemetry management components in a chiplet system, according to an embodiment.

FIG. 3 depicts telemetry management circuitry placement using an IO hub, according to an embodiment.

FIG. 4 depicts telemetry management circuitry placement using a dedicated circuit, according to an embodiment.

FIG. 5 depicts an example connection of chiplets via an interposer and silicon vias, according to an embodiment.

FIG. 6 depicts telemetry management circuitry with interposer monitoring functionality, according to an embodiment.

FIG. 7 depicts a method for telemetry configuration, according to an embodiment.

FIG. 8 depicts a hardware arrangement of a data center used to provide multiple implementations or instances of a computing system, according to an example.

FIGS. 9A and 9B depict arrangements of a chip assembly with expanded views of the chiplets and processing units, according to an example.

FIG. 10 depicts a block diagram of a computing system, according to an example.

### DETAILED DESCRIPTION

Routing system architectures can be configured as input-output (IO) hubs connecting chiplets in a System-on-a-Chip (SoC), System-on-Package (SoP), System-in-a-Package (SiP), or similar package architectures. Such architectures can also include switches connecting SoCs/SiPs and devices in a computing system and connecting computing systems in a rack. A limitation in existing telemetry techniques is the lack of functionality to track and trace applications in an end-to-end fashion at the system level down to the IO hub.

Some approaches for performing telemetry operations are based on the collection and retrieval of data logged in response to specific pre-programmed rules or conditions. For instance, telemetry data from a computing system might be captured and processed at a hardware level, such as by assigning specific hardware elements to monitor a limited number of telemetry counters and receiving callbacks when an overflow occurs on specific telemetry counters. In other scenarios, telemetry data might be processed at a management software stack level, but with the expense of significant overhead and complexity to identify and handle events indicated in the telemetry data. Either scenario can become significantly complex as the scale of computing systems grows since computing systems may be composed of hundreds or thousands of individual processing elements—and thus, potentially millions of potential monitoring counters and triggering events from telemetry.

Additionally, some system IO hub architectures are connecting chiplets in a static manner or based on routing rules that are managed and orchestrated by the IO hub itself. In this regard, there is no consideration of having a software and hardware co-design to improve the efficiency of routing schemes or task/service/application placement within the SoC/SiP. Moreover, there is an inherent gap in the current chiplet-based architectures that do not consider how multiple chiplets that are assembled after manufacturing will work together to provide consistent telemetry metrics and schemes.

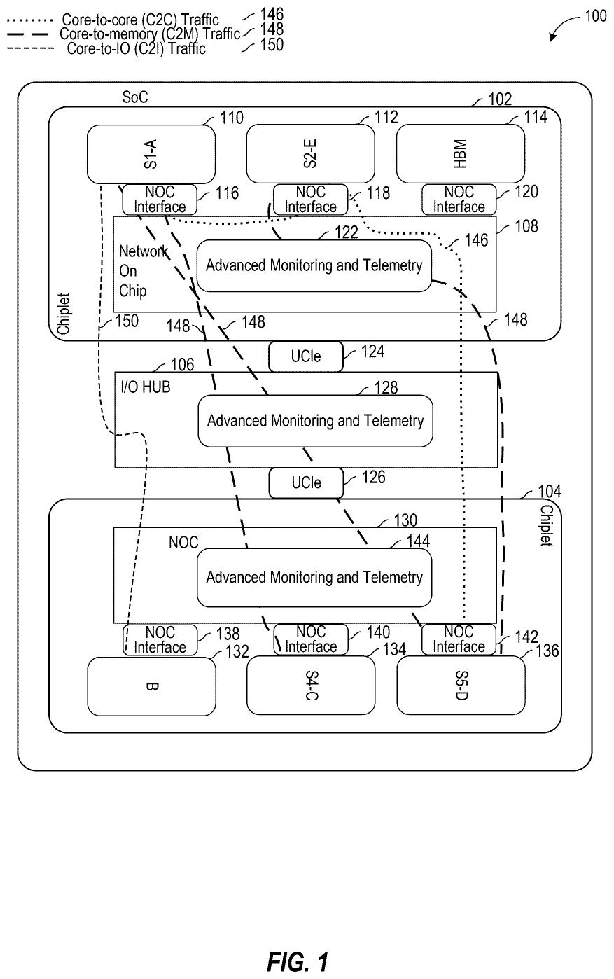

The disclosed telemetry management techniques can be used to configure monitoring chiplets and the chiplet connectors (e.g., universal chiplet interconnect express (UCIe) connectors) state (e.g., thermal state, efficiency, performance, etc.) at different levels and propagate back that information to the software stack to perform more advanced resource management policies. More specifically, the disclosed techniques include configuring advanced monitoring and telemetry (AMT) functions at the IO hub as well as one or more chiplets to provide interoperability and consistent telemetry schemes in a chiplet-based architecture (e.g., SoC). Example AMT functions are discussed in connection with, e.g., FIGS. 1-7.

FIG. 1 depicts a processing circuitry in the form of a chiplet system 100 implementing telemetry management in the form of a telemetry management circuitry, according to an embodiment. Referring to FIG. 1, chiplet system 100 can be configured as an SoC with a plurality of chiplets (e.g., chiplets 102 and 104) coupled via an IO hub 106.

In some aspects, chiplet 102 comprises a network-on-chip (NoC) device 108 and chiplet devices 110, 112, and 114. In some aspects, at least one of the chiplet devices (e.g., chiplet device 114) is a memory device (e.g., a high bandwidth memory (HBM)). Additionally, the chiplet devices 110, 112, and 114 are coupled to the NoC device 108 via corresponding NoC interfaces 116, 118, and 120.

In some aspects, chiplet 104 comprises a NoC device 130 and chiplet devices 132, 134, and 136. Additionally, the chiplet devices 132, 134, and 136 are coupled to the NoC device 130 via corresponding NoC interfaces 138, 140, and 142.

IO hub 106 is coupled to chiplets 102 and 104 via corresponding UCIe interfaces 124 and 126.

In some aspects, IO hub 106 comprises an AMT circuit 128 configured to perform the disclosed telemetry management techniques, including telemetry mechanisms that provide interoperability and consistent telemetry schemes on chiplet-based architectures. In some aspects, an AMT circuit 122 is configured at chiplet 102 (e.g., as part of NoC device 108), and an AMT circuit 144 is configured at chiplet 104 (e.g., as part of NoC device 130).

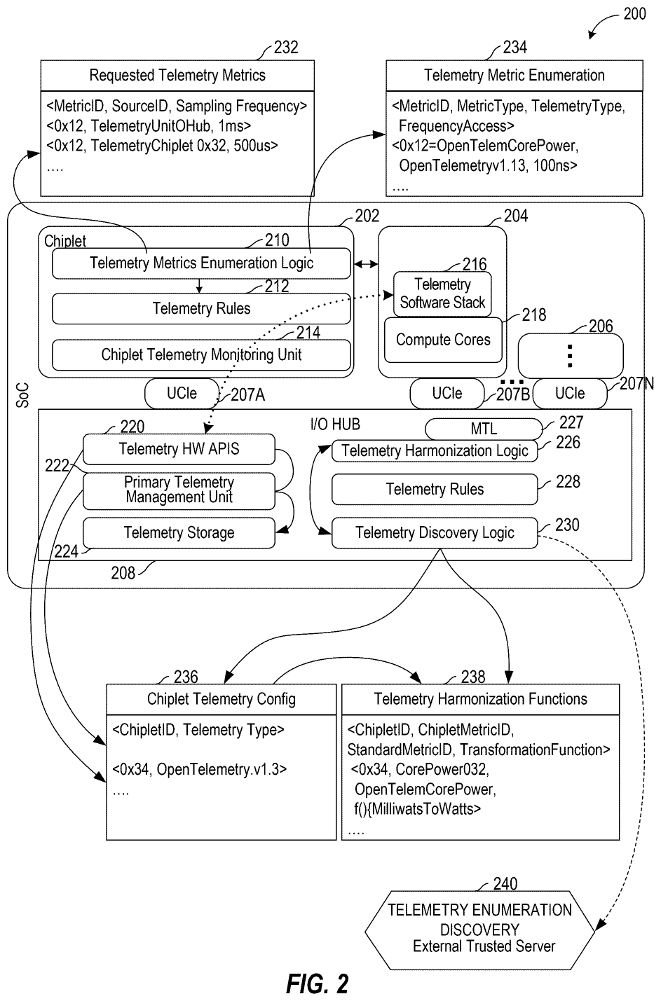

In some aspects, AMT circuit 128 within the IO hub is configured to perform telemetry management functions as illustrated in FIG. 2, including configuring telemetry hardware application programming interfaces (APIs), a primary telemetry management unit (PTMU), telemetry storage, telemetry harmonization logic, telemetry rules, and telemetry discovery logic.

In some aspects, an AMT circuit within a chiplet (e.g., AMT circuit 122 or 144) is configured to perform telemetry management functions as illustrated in FIG. 2, including configuring telemetry metrics enumeration, telemetry rules, and a chiplet telemetry monitoring unit (CTMU). Even though FIG. 2 illustrates an example distribution of telemetry-related functions among the AMT circuits, such distribution is exemplary, and different configurations of the AMT circuits can be used as well.

In some aspects, the disclosed AMT circuit can be used to configure a chiplet system with hierarchical and modular telemetry.

In some aspects, the disclosed AMT circuit can include a monitoring unit in the IO hub (e.g., a PTMU) that exposes interfaces to the software stack components connected to the chiplet system and specify advanced monitoring rules. In some aspects, these rules allow (a) the generation of automatic callbacks to specific software or hardware instances when determined conditions occur and (b) the activation of advanced event tracing for particular IO Hub flows associated when some of the previous callbacks are activated.

In some aspects, the disclosed AMT circuit can be configured to implement quality of service policies in a multi-chiplet architecture.

FIG. 1 further illustrates example functionalities of the AMT circuit 128 in connection with monitoring different types of application traffic. For example, an application may be executed using resources of the chiplet system 100, with the application including a plurality of application functions (e.g., S1, S2, S4, and S5) using different chiplet devices (e.g., application functions S1, S2, S4, and S5 can execute on corresponding chiplet devices 110, 112, 134, and 136, which are also referenced as corresponding devices A, E, C, and D in FIG. 1). The application functions can be associated with the following types of communication flows, which are also called network traffic flows:
(a) Core to IO (C2I) traffic flow 150 (e.g., traffic flow between chiplet devices 110 and 132);
(b) Core to Memory (C2M) traffic flow 148 (e.g., traffic flow between chiplet devices 110 and 134, 110 and 136, and 112 and 136); and
(c) Core to Core (C2C) traffic flow 146 (e.g., traffic flow between chiplet devices 110 and 112, and 112 and 136).

In some aspects, AMT circuit 128 can register the following monitoring rules (e.g., listed in Table 1), which are associated with the application functions S1 and S2 and the associated traffic flows 146, 148, and 150 illustrated in FIG. 1:

TABLE 1
Rule 1: If 1 GBs < (S1.A to B IO BW) < 10 GBs then CallBack
(S1, Monitoring Data);
Rule 2: If (S1.A to S4.C cache latency RD) > 100ms then CallBack
(S1, Monitoring Data);
Rule 3: If (S2.E to D cache latency WR < 100 ms) then CallBack
(S2, Monitoring Data);
Rule 4: If (S1.A to S5.mem BW + S2.mem BW) > 50 then CallBack
(S2, Monitoring Data) & StartTracing (MESSAGES); and
Rule 5: If (S1.A to S5.mem BW + S2.mem BW) < 45 then CallBack
(S2, Monitoring Data) & StopTracing (MESSAGES).

In Table 1, Rules 1-5 configure callbacks to the software stack of the application function with monitoring data when certain traffic conditions (e.g., specific bandwidth, cache latency, or memory usage) are met.

In this regard, the proposed telemetry management techniques using an AMT circuit provide flexible mechanisms to track service-level agreements (SLAs), understand how complex flows behave, monitor communication flows to collect flow telemetry in a scalable way, and facilitate identification of potential bugs or potential resource attacks without interfering with service performance.

In some aspects, the disclosed techniques can be used to configure a set of processing schemes that apply different levels of smart tracing depending on the requirements of the software stack. In some aspects, the disclosed AMT circuits (e.g., AMT circuit 122 and AMT circuit 128) can each be implemented as telemetry management circuitry that can be used to configure monitoring interoperability schemes for a chiplet-based design, monitor physical properties of connectivity means of the chiplet-based design (e.g., silicon vias, an interposer, microbumps, etc.), and configure quality of service schemes. In some aspects, AMT circuit 122 and AMT circuit 128 can be implemented as a single telemetry management circuitry that is part of SoC 100 (e.g., part of any of the chiplets 102 and 104, the IO hub 106, or as a separate circuitry coupled to the IO hub and the chiplets).

Even though FIG. 1 illustrates multiple AMT circuits configured at different circuits within a SoC, the disclosure is not limited in this regard and a single (e.g., dedicated) AMT circuit can be used instead (e.g., as AMT circuit 128 or another circuit within SoC 100 or outside of SoC 100). Additionally, the single AMT circuit (or multiple AMT circuits) can initiate and manage one or more communication flows to configure, retrieve, and manage telemetry rules or perform call-backs to a telemetry software stack (e.g., as illustrated in FIG. 2).

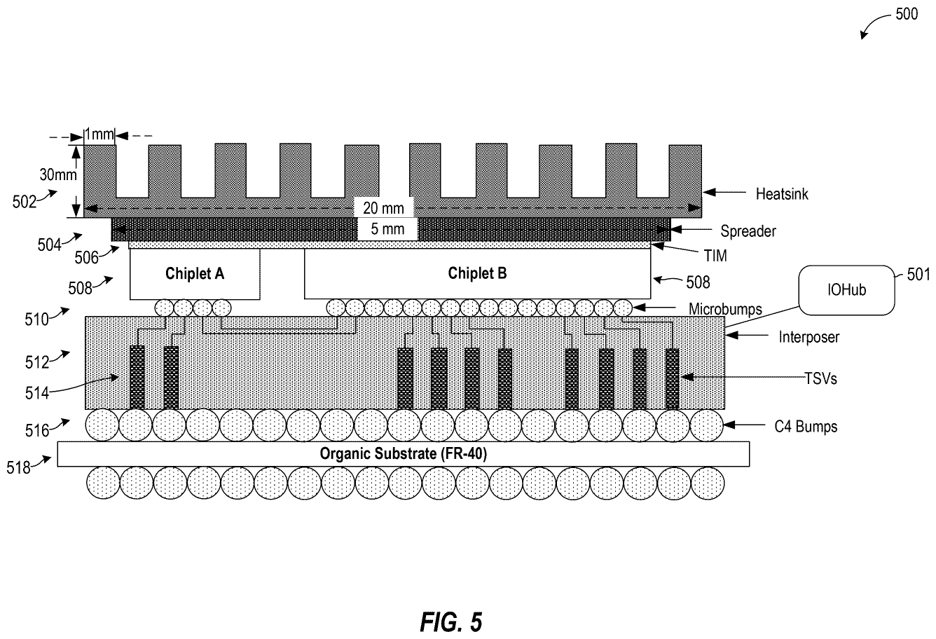

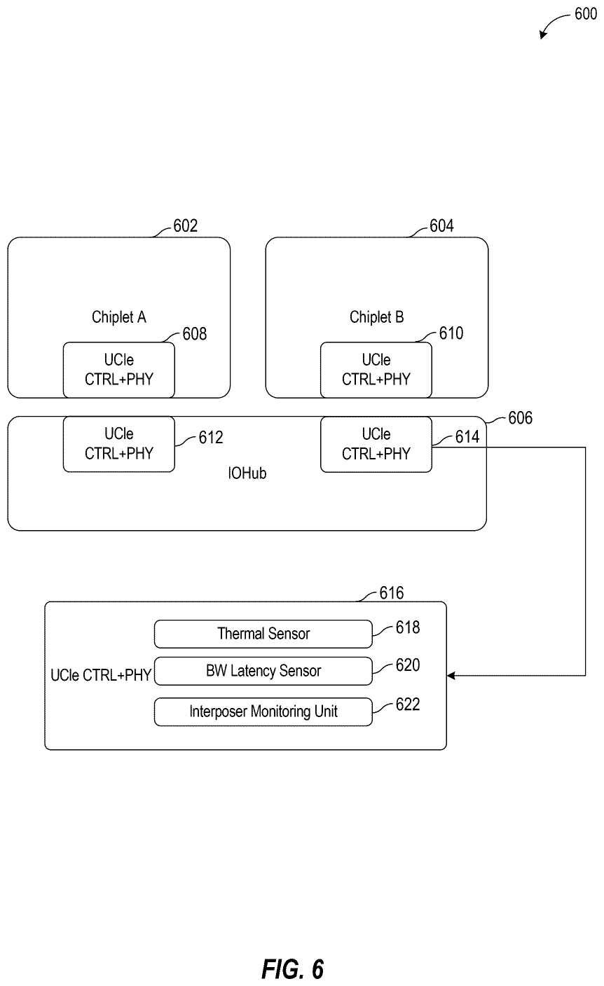

Example monitoring interoperability schemes for a chiplet-based design are discussed in connection with FIGS. 2-4 and 7. Example techniques for monitoring physical properties of connectivity means are discussed in connection with FIGS. 5-6.

FIG. 2 depicts telemetry management components in a chiplet system 200, according to an embodiment. Referring to FIG. 2, the chiplet system 200 (which can be configured as an SoC/SiP) includes chiplets 202, 204, . . . , 206, and an IO hub 208. Chiplets 202, 204, . . . , 206 are coupled to the IO hub 208 via corresponding UCIe interfaces 207A, 207B, . . . , 207N.

In some aspects, one or more of the chiplets 202, . . . , 206 include compute cores, such as compute cores 218 in chiplet 204. In some aspects, compute core 218 can be configured to execute a telemetry software stack 216 associated with one or more AMT-related circuits, such as the circuits included in chiplet 202 and IO hub 208, which are discussed below. In some aspects, an AMT circuit (e.g., at least one of the AMT circuits illustrated in FIG. 1) can include one or more of the AMT-related circuits discussed in connection with FIG. 2.

In some aspects, chiplet 202 includes the following AMT-related circuits: telemetry metrics enumeration logic 210, telemetry rules logic 212, and chiplet telemetry monitoring unit (CTMU) 214. In some aspects, the telemetry metrics enumeration logic 210, the telemetry rules logic 212, and the CTMU 214 can be configured as telemetry management circuitry.

In some aspects, IO hub 208 includes the following AMT-related circuits: telemetry hardware APIs 220, a primary telemetry management unit (PTMU) 222, telemetry storage 224, telemetry harmonization logic 226, telemetry rules logic 228, and telemetry discovery logic 230. In some aspects, the telemetry hardware APIs 220, the PTMU 222, the telemetry storage 224, the telemetry harmonization logic 226, the telemetry rules logic 228, and the telemetry discovery logic 230 can be configured as telemetry management circuitry.

In some aspects, the telemetry metrics enumeration logic 210, the telemetry rules logic 212, the CTMU 214, the telemetry hardware APIs 220, the PTMU 222, the telemetry storage 224, the telemetry harmonization logic 226, the telemetry rules logic 228, and the telemetry discovery logic 230 can be configured as telemetry management circuitry.

In some aspects, the CTMU 214 in chiplet 202 is configured to manage telemetry locally at the chiplet level and to offer telemetry functions to other chiplets or to the PTMU 222 (if configured at the IO hub 208).

In some aspects, the telemetry metrics enumeration logic 210 can be used by the CTMU 214 to discover what telemetries the various components of the chiplet provide and how they are accessed (e.g., specific signals used, a certificate signing request (CSR), a memory address, etc.). In some aspects, the CTMU (or another device) can request telemetry via a requested telemetry metrics record 232, which can include the metric ID, a device/source ID, sampling frequency, etc.

In some aspects, the telemetry metrics enumeration logic 210 can be configured to determine what standard the telemetries follow. For example, a given metric may be provided by a physical compute core about its power consumption, and the format/semantics can follow a specific version of the OpenTelemetry standard.

In some aspects, the telemetry metrics enumeration logic 210 can be configured to determine the frequency of updates of the telemetry and other telemetry-related information.

In some aspects, the telemetry metrics enumeration logic 210 can be configured to store the following telemetry configuration associated with metrics the CTMU has to access: the metric that needs to be accessed and to which device the data needs to be provided. Examples of recipient devices could include the PTMU 222, another telemetry unit from another chiplet, or stored in the local storage area to be accessed by the software stack.

In some aspects, the discovered telemetry information can be stored as one or more telemetry metric enumeration records (such as the telemetry metric enumeration record 234).

In some aspects, the telemetry rules logic 212 and the telemetry rules logic 228 provide functionalities that enable setting triggers that can be activated on certain conditions (e.g., to activate callbacks to the software stack, activate tracing, etc.). In some aspects, the telemetry rules logic 212 can be configured with one or more data collection criteria filters, such as AND/OR of collection criteria, upper/lower ranges in data collection, random sample picking, etc.

In some aspects, the telemetry rules logic 212 can be configured with software (SW)-based/FPGA-type telemetry triggering for a more flexible data collection. In some aspects, the SW-based triggering may need an additional processing time at any of the AMT-related circuits (e.g., so that a sub-millisecond telemetry event is not missed). In this regard, the telemetry rules logic 212 can be configured to perform phenomena prediction (e.g., predicting a telemetry event resulting in desired telemetry) by detecting parameter tendencies (e.g., based on analysis of historical telemetry data).

In some aspects, the telemetry rules logic 212 and the telemetry rules logic 228 allow the registration of rules that are evaluated periodically to check whether they are asserted or not. In some aspects, an example rule registration sequence includes the following configurations:
(a) A rule can be defined as a Boolean operation that asserts true or false. The Boolean operation can include an element within a processing tile (e.g., Tile1.Cache), a metric within the element (e.g., Tile1.Cache.MissRate), and an arithmetic or Boolean operation (e.g., Tile1.Cache.MissRate>90).
(b) The frequency at which the rule needs to be checked. The frequency can be defined as a value (e.g., 90) and a metric (e.g., nanoseconds).
(c) The telemetry action to be performed. As used herein, the term “telemetry action” refers to at least one action that is performed (e.g., automatically) upon execution of a telemetry-related rule. For example, the telemetry action can include generating a notification, executing a process, executing a function, executing an application, or performing another action (or canceling the execution of an action) based on satisfying one or more constraints defined by the rule. Example telemetry actions include:
(c.1) Callback to the telemetry software stack 216 (or another management software stack). This could be a pointer to memory that triggers a ring bell to the software stack or a software interrupt.
(c.2) A specific telemetry action to be performed by the CTMU 214 or the PTMU 222. Examples of telemetry actions include sending a signal to the management tile, initiating a trace of certain metrics during a period of time, and storing the monitoring metrics in a region of memory.

In some aspects, chiplet 202 may contain memory (e.g., SRAM) that is configured to store telemetry data that the CTMU 214 is monitoring and that can be accessed by the telemetry software stack 216 (or another management software stack).

In some aspects, PTMU 222 is configured to orchestrate the telemetry management at the SoC/SiP level.

In some aspects, the telemetry discovery logic 230 is used by the PTMU 222 to discover and enumerate metrics that are available in each of the chiplets 202, 204, . . . , 206. In some aspects, PTMU 222 will work with the telemetry metrics enumeration logic 210 in each of the chiplets to perform such enumeration. In some aspects, at reset time or at the first boot time, the telemetry discovery logic 230 will enumerate and store the available metrics.

In some aspects, discovery and enumeration of telemetry metrics may be performed asynchronously at the IO hub 208 and the core chiplets. In this regard, the telemetry metrics can be configured to include time data (e.g., a timestamp) so that such data can be matched and processed sequentially by any of the AMT-related circuits.

In some aspects, the telemetry discovery logic 230 may have been pre-configured in a ROM or similar persistent media telemetry harmonization functions (which can also be used by the telemetry harmonization logic 226). These functions allow for the transformation of metrics provided by specific chiplet designs/manufacturers to a standard or a common metric format (e.g., a metric format pre-configured for the chiplet system 200). For example, as shown in FIG. 2, the telemetry discovery logic 230 can retrieve telemetry harmonization functions 238 that can be applied (e.g., chiplet 0x34 may provide power consumption in milliwatts while the standard used defines that it should be provided in watts, chiplet may provide available bandwidth as CPU usage while the standard used defines that it should be provided in total computing resource availability, etc.).

In some aspects, the telemetry discovery logic 230 can be configured to access an external service 240 during the discovery process to fetch one or more chiplet telemetry configurations (such as chiplet telemetry configuration 236) from a trusted server. In some aspects, this information could also be retrieved periodically to retrieve updates on metric definitions or standards. In some aspects, the retrieved chiplet telemetry configuration 236 can be stored in telemetry storage 224.

In some aspects, PTMU 222, on request from the telemetry software stack 216, can maintain a configuration table where the type of metrics being requested is stored. In some aspects, this table can maintain a metric ID and a resource ID (e.g., the telemetry software stack 216 may require power metrics for only a subset of chiplets or cores within the subsystem).

In some aspects, PTMU 222 uses the telemetry harmonization logic 226 during the process of collecting telemetry from the various components to retrieve telemetry, detect an incompatibility between a metrics format of at least one metric and a common metrics format associated with the chip system, apply one or more harmonization functions (if necessary) to address the incompatibility and store the metric for consumption.

In some aspects, the common metric format can be based on a library of metrics and transformation functions. For example, some metric transformations can be vendor-specific, and some transformations can be standard-based.

In some aspects, the telemetry harmonization logic 226 can include baseline definitions of standard telemetry metrics as well as additional definitions that are vendor-specific. In this regard, the telemetry harmonization logic 226 can include a metric transformation library (MTL) (e.g., MTL 227) that includes at least the following two levels associated with applying telemetry harmonization functions and metric transformations:
(a) Standard transformation level. MTL 227 can include a library that is based on standard transformations that, for example, translate from standard A to standard B (e.g., standard B can be a common metric format). An example could be telemetry provided by a chiplet based on an ARM architecture (e.g., standard A) is converted to another telemetry format (e.g., standard B format, which can be RISC—V-based format).
(b) Vendor-specific transformation level. MTL 227 can include a library that is expanded to include vendor-specific telemetry transformations. For example, the telemetry harmonization logic 226 can use MTL 227 to harmonize telemetry provided by a chiplet based on RISC-V extensions architecture (e.g., standard A associated with Vendor A) to another telemetry format (e.g., standard B, which can be RISC—V-based telemetry associated with vendor B).

In some aspects, the telemetry harmonization logic 226 can communicate with an external entity to validate the function authenticity or retrieve the function from the external entity (e.g., after the attestation of the chiplet).

In some aspects, the telemetry harmonization logic 226 uses a telemetry harmonization function such as a transformation function (TF) (e.g., as retrieved from MTL 227) to convert multiple common metrics (e.g., metrics defined according to a first metrics-related protocol or a first configuration) to vendor-specific metrics (e.g., metrics defined according to a second metrics-related protocol or configured by a vendor) (or vice versa). The transformation equation can be as follows: (CommonMetric1, . . . , CommonMetricN)=TF(VendorMetric1, . . . , VendorMetricM). In some aspects, the common metrics or vendor-specific metrics can include data structures (e.g., one or more matrices) of related/associated metrics.

In some aspects, the TF is configured to calculate (or derive) a new metric. For example, the telemetry harmonization logic 226 determines a metric is a non-common metric (e.g., the metric is not defined by the first metrics-related protocol or the second metrics-related protocol). In this case, a new metric that is equivalent to the common metric could be calculated (or derived) and inserted into the telemetry harmonization logic 226. Separately, the harmonization function itself (e.g., the TF) could be a calculation derived from several telemetry metrics that, in this case, are not part of the common metric.

In some aspects, the telemetry rules logic 228 is responsible for providing mechanisms to define events based on the telemetry being observed at the PTMU 222, similar to the CTMU 214. In some aspects, rules can be defined by setting source and destination chiplets or telemetry coming from the system level outside the chiplets (e.g., metrics that the IO hub provides). In some aspects, the rules can be specified in a telemetry configuration. In this regard, the PTMU can parse the telemetry configuration to obtain a rule specifying a telemetry action that can be performed in connection with a telemetry.

In some aspects, PTMU 222 can retrieve a chiplet telemetry configuration 236 (e.g., from telemetry storage 224) and initiate telemetry configuration and collection by accessing the relevant hardware (e.g., via the telemetry hardware APIs 220). Telemetry results can be harmonized (if needed) by the telemetry harmonization logic 226 and can be stored in telemetry storage 224. In some aspects, PTMU 222 can encode a notification with telemetry results for transmission to a management circuit.

Referring to FIG. 1 and FIG. 2, the disclosed techniques can be used to configure processing circuitry (e.g., chiplet system 200, which can be configured as an SoC). In some aspects, the processing circuitry includes compute circuitry. In some aspects, the compute circuitry includes hardware resources configured to perform compute operations in a computing platform. For example, the compute circuitry comprises the compute cores 218 in chiplet 204 or hardware resources in other chiplets of the SoC.

In some aspects, the processing circuitry includes telemetry management circuitry. For example, the telemetry management circuitry comprises one or more of the following circuits: telemetry metrics enumeration logic 210, telemetry rules logic 212, CTMU 214, telemetry hardware APIs 220, PTMU 222, telemetry storage 224, telemetry harmonization logic 226, telemetry rules logic 228, and telemetry discovery logic 230.

In some aspects, the telemetry management circuitry is configured to detect a communication flow for an application function. In some aspects, the application function is associated with a process executing on at least one of the hardware resources. In some aspects, the telemetry management circuitry is configured to retrieve a telemetry configuration (e.g., chiplet telemetry configuration 236) based on the communication flow. The telemetry configuration identifies at least one metric of a preconfigured metric type for the process executing on the at least one of the hardware resources. In some aspects, the telemetry management circuitry is configured to execute a trace on the at least one metric to obtain metrics results. In some aspects, the telemetry management circuitry is configured to perform a telemetry action based on the metrics results.

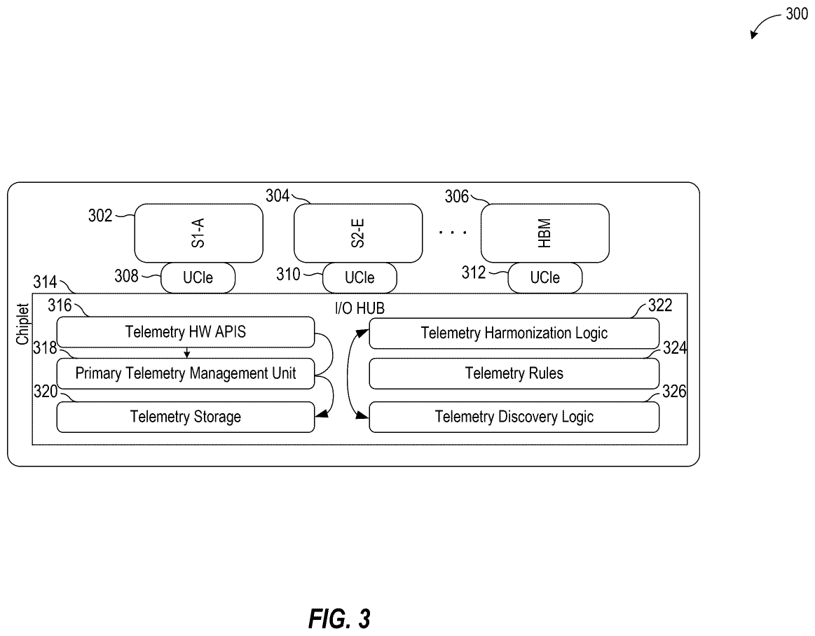

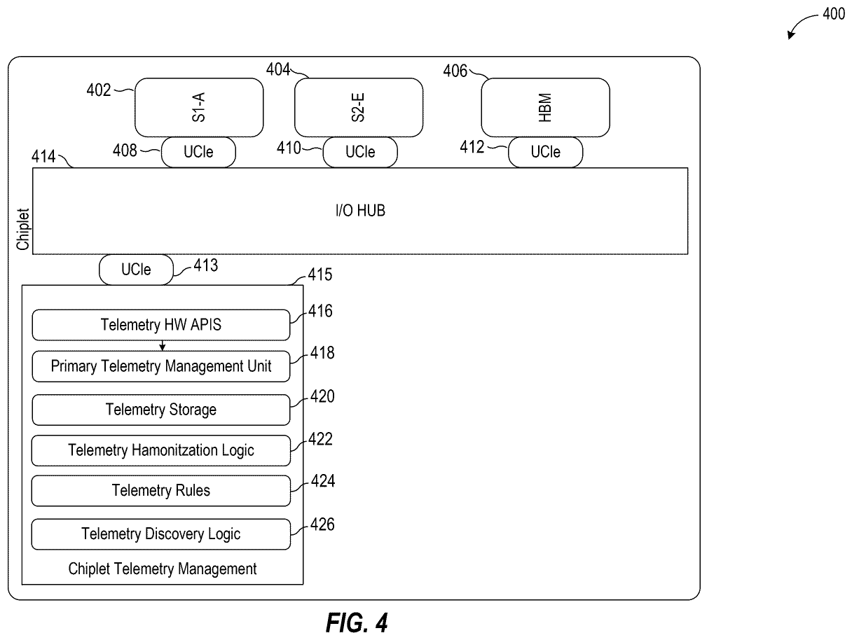

In some aspects, the logic associated with the PTMU 222 can be configured at different locations within a chiplet system (e.g., as illustrated in FIGS. 3-4), depending on the solution.

FIG. 3 depicts telemetry management circuitry placement using an IO hub, according to an embodiment. Referring to FIG. 3, chiplet 300 includes chiplet devices 302, 304, . . . , 306 coupled to an IO hub 314 via corresponding UCIe interfaces 308, 310, . . . , 312. In some aspects, AMT-related circuitry and logic are configured as part of the IO hub 314. More specifically, IO hub 314 includes the following AMT-related circuits: telemetry hardware APIs 316, PTMU 318, telemetry storage 320, telemetry harmonization logic 322, telemetry rules logic 324, and telemetry discovery logic 326. The telemetry hardware APIs 316, PTMU 318, telemetry storage 320, telemetry harmonization logic 322, telemetry rules logic 324, and telemetry discovery logic 326 can perform similar functions as corresponding circuits of FIG. 2 (e.g., telemetry hardware APIs 220, PTMU 222, telemetry storage 224, telemetry harmonization logic 226, telemetry rules logic 228, and telemetry discovery logic 230).

FIG. 4 depicts telemetry management circuitry placement using a dedicated circuit, according to an embodiment. Referring to FIG. 4, chiplet 400 includes chiplet devices 402, 404, . . . , 406 coupled to an IO hub 414 via corresponding UCIe interfaces 408, 410, . . . , 412.

In some aspects, AMT-related circuitry and logic are configured as part of a dedicated circuit, such as the chiplet telemetry management circuit 415, which is coupled to the IO hub 414 via UCIe interface 413. The chiplet telemetry management circuit 415 includes the following AMT-related circuits: telemetry hardware APIs 416, PTMU 418, telemetry storage 420, telemetry harmonization logic 422, telemetry rules logic 424, and telemetry discovery logic 426. The telemetry hardware APIs 416, PTMU 418, telemetry storage 420, telemetry harmonization logic 422, telemetry rules logic 424, and telemetry discovery logic 426 can perform similar functions as corresponding circuits of FIG. 2 (e.g., telemetry hardware APIs 220, PTMU 222, telemetry storage 224, telemetry harmonization logic 226, telemetry rules logic 228, and telemetry discovery logic 230).

In some aspects, the disclosed AMT-related circuits performing the disclosed telemetry management functions can be configured at multiple chiplets within an SoC/SiP, and a single chiplet can act as the primary chiplet (e.g., the chiplet with the PTMU).

In some aspects, the disclosed techniques can be used to monitor how intra-chiplet connectors are working to communicate traffic across the various chiplets connected via the interposer and I/O Hub. FIG. 5 provides one type of physical way to connect chiplets, where the disclosed techniques can be used to monitor the interposer.

FIG. 5 depicts an example connection of chiplets via an interposer and silicon vias, according to an embodiment. Referring to FIG. 5, SoC 500 can include IO hub 501, a heatsink 502, spreader 504, TIM 506, chiplets 508, microbumps 510, interposer 512, through silicon vias (TSVs) 514, bumps 516, and substrate 518.

In some aspects, SoC 500 can be configured with sensors that are connected to a telemetry unit (e.g., a PTMU). In some aspects, the following telemetry-related functionalities can be configured at the IO hub and chiplet levels:
(a) The UCIe interposer can be extended with a set of sensors that allows monitoring of thermal metrics, resource usage metrics, etc.
(b) The UCIe interposer can be configured with a telemetry management unit that allows the IO hub (or even other external entities) to access this telemetry.
(c) The IO hub, which is responsible for interconnecting multiple chiplets, can also monitor various telemetry aspects of the UCIe interposer connectors and map out the process address space IDs (PASIDs) that are using the UCIe and the IO hub to communicate.
(d) The IO hub can be configured with a requirement translation table to understand a potential mapping of other universal unique identifiers (UUIDs) (e.g., a virtual channel) to connect chiplets to the PASID.
(e) The IO hub can be configured with the PTMU to gather telemetry and store it in hot, warm, or cold storage.

In some aspects, IO hub 501 (which can be the same as IO hub 208 of FIG. 2 or IO hub 606 of FIG. 6) can be configured to provide telemetry-related functions associated with, e.g., chiplets 508 and interposer 512. In this regard, one or more sensors or telemetry monitoring circuitry can be configured as part of the interposer 512, which can be used by the IO hub 501 in connection with the telemetry-related functions. In some aspects, interposer 512 can be configured as part of the IO hub 501, or IO hub 501 can be configured separately from interposer 512 (e.g., as illustrated in FIG. 5).

FIG. 6 depicts telemetry management circuitry with interposer monitoring functionality, according to an embodiment. Referring to FIG. 6, SoC 600 can include chiplets 602 and 604, IO hub 606, and interposer 616. Chiplets 602 and 604 can communicate with IO hub 606 via UCIe interfaces 608, 610, 612, and 614. Additionally, IO hub 606 communicates with interposer 616 via UCIe interface 614.

Interposer 616 can include a thermal sensor 618, a bandwidth latency sensor 620, and an interposer monitoring unit 622. In some aspects, the interposer monitoring unit 622 can monitor interposer metrics via the thermal sensor 618 and the bandwidth latency sensor 620 and report the metrics to the IO hub 606.

In some aspects, the interposer monitoring unit 622 can be configured as part of the IO hub 606.

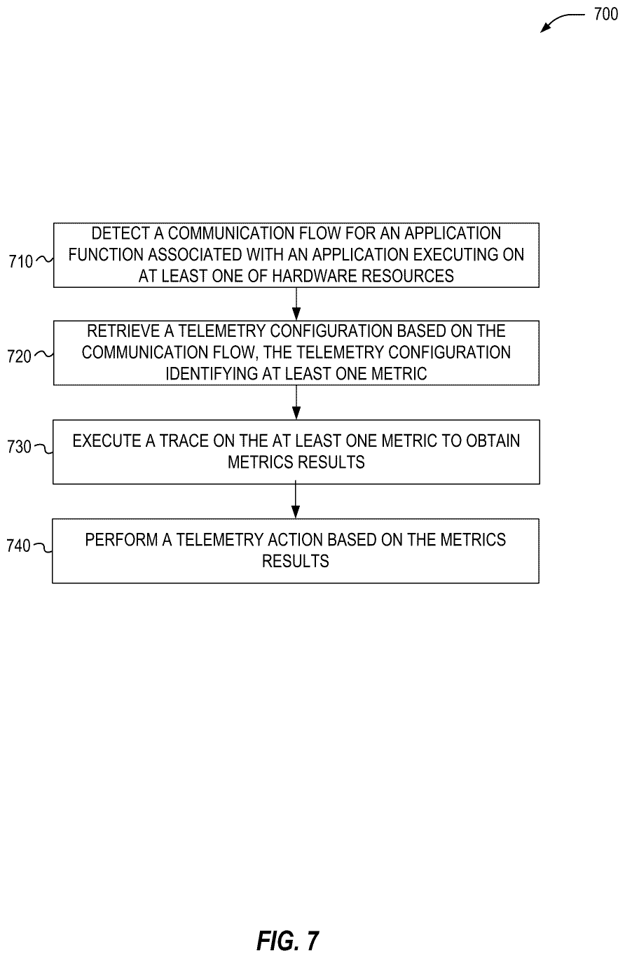

FIG. 7 depicts method 700 for telemetry configuration, according to an embodiment. The operations of method 700 are performed by computational hardware, such as that described above or below (e.g., processing circuitry including telemetry management circuitry).

At operation 710, PTMU 222 can detect a communication flow for an application function. For example, PTMU 222 can detect one of the traffic flows 146, 148, or 150 associated with an application that is executed on chiplet 102.

At operation 720, PTMU 222 retrieves a telemetry configuration based on the communication flow. For example, PTMU 222 can use telemetry discovery logic 230 to retrieve a chiplet telemetry configuration associated with one or more chiplets. In some aspects, the telemetry configuration (e.g., chiplet telemetry configuration 236) can identify at least one metric for the one or more chiplets.

At operation 730, PTMU 222 can execute a trace on the at least one metric to obtain metrics results.

At operation 740, PTMU 222 can perform a telemetry action based on the metrics results (e.g., as specified by the chiplet telemetry configuration 236 or the telemetry rules logic 228).

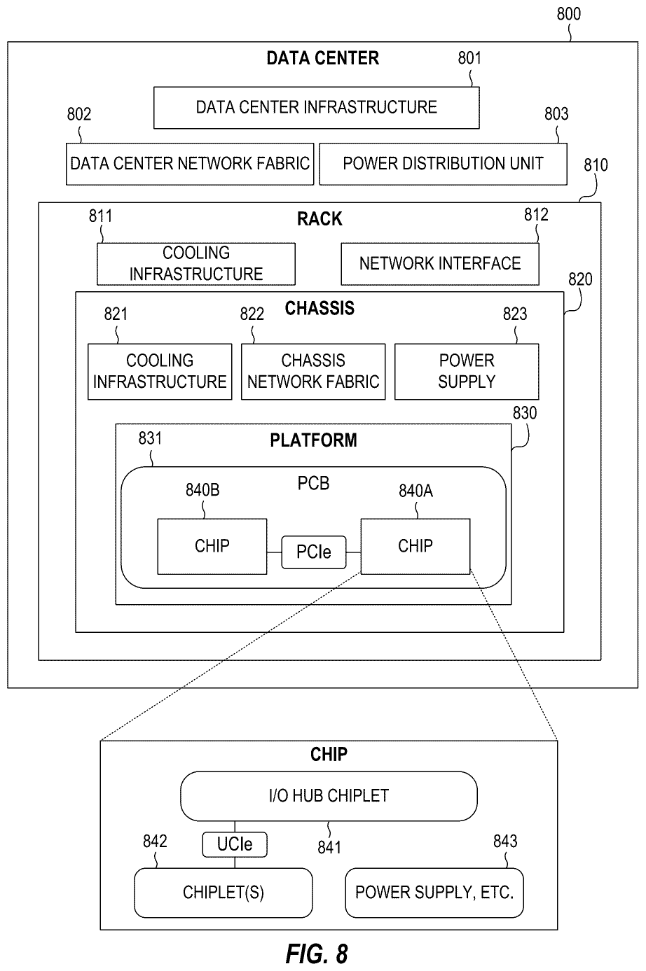

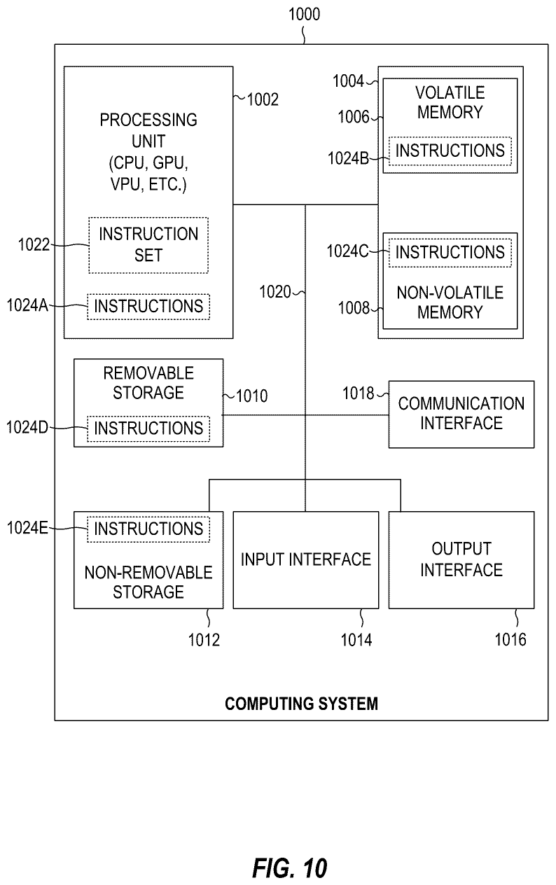

FIGS. 8, 9A, 9B, and 10 depict simplified aspects of example computing architectures in which any of the techniques and configurations above may be implemented. It will be understood that the elements described above for chiplet composability may be integrated into various forms of the following hardware components.

FIG. 8 depicts an example hardware arrangement of a data center 800 used to provide multiple implementations or instances of a computing system (e.g., computing system 1000, discussed below), with each instance of the computing system being identified as a respective platform (e.g., platform 830). The data center 800 includes data center infrastructure 801, a data center network fabric 802, and a power distribution unit 803 to support multiple racks of compute platforms, with a single instance of rack 810 depicted. The data center infrastructure 801 may provide physical components that host the compute platform hardware, storage components, and networking equipment; the data center network fabric 802 may include switches and networking components to support data flows among various compute platforms and storage devices throughout the data center; and the power distribution unit 803 may include components to distribute and control power among the various compute platforms, networking, and storage devices.

The rack 810 includes but is not limited to cooling infrastructure 811, a network interface 812, and related physical components (not shown) to support discrete instances of multiple chassis. The rack 810 provides power, connectivity, and cooling to each of the multiple chassis in a single rack, with a single instance of a chassis 820 depicted in FIG. 8. The chassis 820 includes but is not limited to cooling infrastructure 821, a chassis network fabric 822, and a power supply 823, which provides cooling, network connectivity, and power to multiple platforms within the chassis, with a single instance of a platform 830 depicted in FIG. 8. It will be understood that a common data center rack configuration may include dozens of chassis, with each chassis adapted to support a number of platforms depending on the physical size of the platform hardware and supporting equipment.

Platform 830, in some implementations, may be referred to as a server or node, depending on the use case for platform 830 and data center 800. Platform 830 includes but is not limited to the implementation of a discrete computing system hosted on a single board. Platform 830 is depicted as hosting a chip assembly 840A and chip assembly 840B on a first board provided by a printed circuitry board (PCB) or other platform board, shown as PCB 831. In some examples, platform 830 may include only one chip package. In contrast, PCB 831 depicts the interconnection of multiple chip assemblies via a device-to-device interface (e.g., a PCI express (PCle) or compute express link (CXL) interface). Additional chip packages and components (not shown) may also be hosted on the PCB 831.

Some implementations of the chip assembly 840A and 840B may be termed as a System-on-Chip (SoC) package, as modular chiplets that perform different functions are integrated into a single package-even though this chip package is composed of multiple dies, unlike a traditional SoC design that uses a single die. Other implementations of the chip assembly 840A and 840B may be termed as a System-on-Package (SoP), System-in-a-Package (SiP), or similar references to a single chip package. Various combinations of 2D, 2.5D, and 3D packaging technologies may be used to manufacture and assemble the chip package and its underlying structure, and different manufacturing processes may be used to provide chiplets and components from different process nodes (e.g., semiconductor fabrication systems).

The chip assembly 840A and chip assembly 840B are packages that include multiple chiplets or dies for respective functions, such as separate chiplets for processing (e.g., CPU or GPU chiplets), memory (e.g., cache or high-bandwidth memory chiplets), I/O (e.g., I/O chiplets), acceleration (e.g., AI/ML acceleration chiplets), signal processing (e.g., audio or video processing chiplets), and the like. A close-up of the chip assembly 840A is depicted as including an I/O Hub chiplet 841, chiplets 842, and a power supply 843. These components may be hosted on an interposer that is designed to connect multiple dies or components within a single semiconductor package (e.g., chip package). In some examples, the chiplets 842 may be manufactured and sourced separately and later assembled into the chip package to create the chip assembly 840A. Various connections may be provided among the chiplets 842, such as with the use of Universal Chiplet Interconnect Express (UCIe) or similar chiplet-to-chiplet interfaces and interconnects (e.g., Advanced Interface Bus (AIB), Bunch of Wires (BoW), etc.), or between chiplets and on-chip memory (e.g., high-bandwidth memory (HBM)) using HBM3 (JEDEC), Universal Memory Interface (UMI), or other memory interfaces. Similar interfaces and interconnects may be used for chip-to-chip or die-to-die communications (e.g., using NVIDIA® NVLink-C2C, Cache Coherent Interconnect for Accelerators (CIX), Compute Express Link (CXL), Advanced eXtensible Interface (AXI), and specific implementations of PCIe, CXL, etc.).

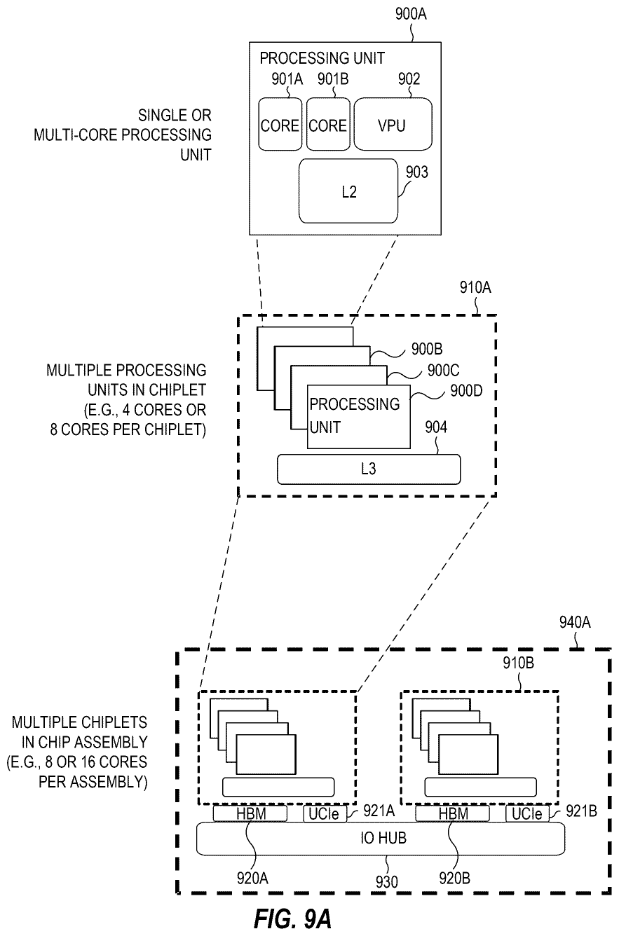

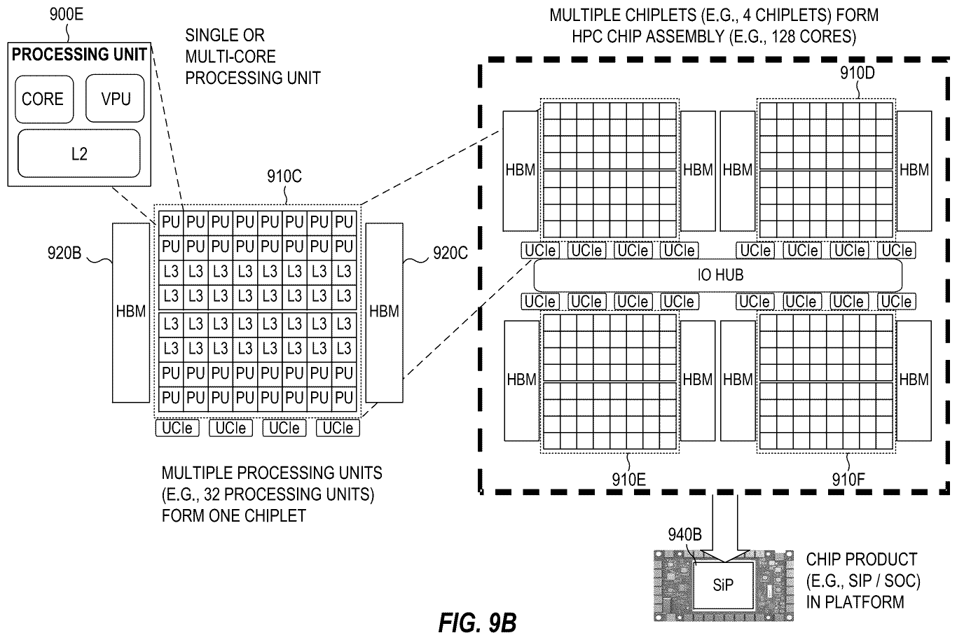

FIG. 9A depicts an example arrangement of a chip assembly 940A (e.g., a multi-processing core implementation of chip assembly 840A or 840B), with expanded views of the chiplets and processing units included therein. This arrangement shows how the chip assembly 940A, which may constitute a SoC, SoP, SiP, or other type of chip package, is composed of chiplets such as chiplet 910A, chiplet 910B, etc., and associated on-package memory (e.g., high-speed memory) such as 3D-stacked HBM instances shown as HBM 920A, HBM 920B, interfaces (e.g., UCIe interfaces) shown as UCIe 921A, UCIe 921B, and I/O hub 930 (e.g., which may be implemented by an I/O chiplet). Other hardware elements of a chip package are not depicted for simplicity.

Each chiplet includes multiple processing units, and each processing unit includes one or multiple cores. For instance, chiplet 910A, as depicted, includes four processing units (processing unit 900A, processing unit 900B, processing unit 900C, and processing unit 900D) and an L3 cache 904. Each processing unit may include one or multiple processing cores, one or multiple caches, and, optionally, other processing units or elements. For instance, processing unit 900A is depicted as including two cores (core 901A and core 901B), vector processing unit 902, and an L2 cache 903. Accordingly, a single-core processing unit arrangement can provide 4 cores per chiplet and 8 total cores in a two-chiplet chip assembly, whereas a dual-core processing unit arrangement can provide 8 cores per chiplet and 16 total cores in a two-chiplet chip assembly. Other permutations may also be provided. A variety of signaling interfaces and protocols (not shown) may be used for core-to-core and inter-processor communications, including but not limited to the use of coherency protocols, mesh, ring, or hybrid ring-mesh interconnects, Network-on-Chip (NoC), and packet-switched communications and the like.

FIG. 9B depicts an example arrangement of a chip assembly 940B (e.g., a multi-chiplet high-performance computing (HPC) implementation of chip assembly 840A, 840B), adapted for HPC applications (e.g., parallel processing operations involving thousands, millions, or more of processors or cores operating simultaneously). The example chip assembly 940B depicts placement as a SiP, SoC, or other package onto a platform board (e.g., PCB 831) and optionally in a data center (e.g., data center 800) or in a standalone deployment setting (e.g., in a standalone computer system, mobile computing device, autonomous device, etc.).

The chip assembly 940B is composed of multiple chiplets, shown with four chiplets: chiplet 910C, chiplet 910D, chiplet 910E, and chiplet 910F. Each chiplet includes multiple processing units, such as 32 processing units with a corresponding L3 cache for each processing unit. Each processing unit may include one or multiple cores, such as a single-core processing unit 900E shown as part of the chiplet 910C. The chip assembly 940B is also composed of corresponding memory resources, such as HBM elements corresponding to respective banks of processing units (e.g., HBM 920B and HBM 920C corresponding respective sets of processing units of chiplet 910C), UCIe interfaces, and an IO Hub.

The chip assembly and related products or devices described herein may be configured in a variety of computing system implementations. Such implementations include machine-readable non-transitory media storing machine-readable instructions and one or more processors coupled to the memory, such that executing the machine-readable instructions configures the computing system and implementing hardware (e.g., the processing unit 900, chiplet 910, chip 840, platform 830) to perform steps and operations described above for electronic systems or devices (e.g., to perform chiplet composability, etc.). It should be further understood that software including one or more computer-executable instructions that facilitate processing and operations as described above may be distributed, installed, or otherwise provided with networked devices (e.g., servers or cloud computing systems). Alternatively, in some examples, the software may be obtained and loaded (or re-loaded/upgraded) from one or more servers and/or cloud computing systems, such as software stored on a server for distribution over the Internet, for example.

FIG. IO depicts a block diagram of an example computing system 1000 (e.g., device, apparatus, machine, etc.) that may be programmed into a special purpose machine suitable for implementing one or more embodiments for chiplet composability and like aspects disclosed herein. For instance, the chiplets, interconnect platforms, or other components described above may be embodied by the computing system 1000, such as in the form of a computer or specialized electronic device that includes sufficient processing power, memory resources, and communications throughput capability to perform operations consistent with the examples herein.

The computing system 1000 may include at least one hardware processing unit 1002, such as a central processing unit (CPU), a graphics processing unit (GPU), a vector processing unit (VPU), a neural processing unit (NPU), a hardware accelerator, or combinations or variants thereof. The at least one hardware processing unit 1002 is an implementation of processor circuitry and may be embodied by various types of chip assemblies, products, or packages, as discussed with reference to FIGS. 8 to 9B. Circuitry (e.g., processing circuitry), as used herein, is a collection of circuits implemented in tangible entities of the computing system 1000 that includes hardware (e.g., simple circuits, gates, logic, etc.). Circuitry membership may be flexible over time. Circuitries include members that may, alone or in combination, perform specified operations when operating. In some examples, the hardware of the circuitry may be immutably designed to carry out a specific operation (e.g., hardwired).

In an example, the hardware of the circuitry may include variably connected physical components (e.g., execution units, transistors, simple circuits, etc.), including a machine-readable medium physically modified (e.g., magnetically, electrically, moveable placement of invariant massed particles, etc.) to encode instructions of the specific operation. In connecting the physical components, the underlying electrical properties of a hardware constituent are changed, for example, from an insulator to a conductor or vice versa. The instructions enable embedded hardware (e.g., the execution units or a loading mechanism) to create members of the circuitry in hardware via the variable connections to carry out portions of the specific operation when in operation. Accordingly, the machine-readable medium elements can be part of the circuitry or communicatively coupled to the other components of the circuitry when the device is operating. Also, in some examples, any of the physical components may be used in more than one member of more than one circuitry. For example, under operation, execution units may be used in a first circuit of a first circuitry at one point in time and reused by a second circuit in the first circuitry or by a third circuit in a second circuitry at a different time.

The computing system 1000 may also include at least one memory device 1004, such as volatile memory 1006 and non-volatile memory 1008, and at least one storage device, such as removable storage 1010 and/or non-removable storage 1012, such as a drive unit, some or all of which may communicate with each other via an interconnect, fabric, link, or bus 1020.

The computing system 1000 may include an output interface 1016, such as an interface connected to a display device and an input interface 1014, such as an interface connected to an alphanumeric input device or a user interface (UI) navigation device. In some examples, a connected I/O device may also include a display device, an alphanumeric input device, and a navigation device that is integrated into a single unit, such as a touchscreen display.

The computing system 1000 may additionally include a communication interface 1018, such as for connection with a network interface device used to transmit and receive electronic signals on a network. The computing system 1000 may also include other interfaces or hardware (not shown) in connection with a signal generation device (e.g., an audio or radio signal generation device), an output controller (e.g., for connection with a serial, universal serial bus (USB), parallel, or other wired or wireless connection such as which uses via infrared (IR) or near field communication (NFC) technologies), an input controller (e.g., for connection with sensors or peripheral devices), and the like.

Any of the memory or storage devices, such as the volatile memory 1006, the non-volatile memory 1008, the removable storage 1010, or the non-removable storage 1012 may provide a machine-readable medium. Some examples of a machine-readable medium are a non-transitory medium that hosts or stores one or more sets of data structures or instructions (e.g., software instructions) embodying or utilized by any one or more of the techniques or functions described herein. Such instructions are collectively labeled as instructions 1024 with respective implementations of instructions 1024A, 1024B, 1024C, 1024D, and 1024E.

The instructions 1024 may reside, during execution or other operation of the computing system 1000, entirely or at least partially within the volatile memory 1006 as instructions 1024B, within non-volatile memory 1008 as instructions 1024C, within removable storage as instructions 1024D, within non-removable storage as instructions 1024E, or within the hardware processing unit 1002 as instructions 1024A. Thus, any combination of the hardware processing unit 1002, the volatile memory 1006, the non-volatile memory 1008, or a storage device of the removable storage 1010 or non-removable storage 1012 may constitute a machine-readable medium or media. The instructions 1024A, when loaded and executed by the hardware processing unit 1002, may invoke or utilize a defined instruction set 1022 of the hardware processing unit 1002, such as a processor instruction set defined by an instruction set architecture (ISA) of a reduced instruction set computer (RISC) or complex instruction set computer (CISC) architecture-including but not limited to the RISC-V Instruction Set provided in a RISC-V architecture. It will be understood that a RISC-V architecture and instruction set is one of several available architectures and instruction sets that may be used in implementations of the functional compute components (e.g., the hardware processing unit 1002) discussed herein.

The term “machine-readable medium” may include any medium that is capable of storing, encoding, or carrying instructions for execution by components or the whole of the computing system 1000 (or a similar machine), and that cause the computing system 1000 or its components to perform any one or more of the techniques or functions described herein or that is capable of storing, encoding, or carrying data structures used by or associated with such instructions. Non-limiting machine-readable medium examples may include solid-state memories and optical and magnetic media. Specific examples of machine-readable media may include non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; and optical or magneto-optical disks.

The instructions 1024 may further be transmitted or received over a communications network using a transmission medium via the communication interface 1018 and related devices utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), and wireless data networks (e.g., Institute of Electrical and Electronics Engineers (IEEE) 802.11 family of standards known as Wi-Fi®), IEEE 802.15.4 family of standards, peer-to-peer (P2P) networks, among others.

Method examples or other operations described herein can be implemented in part or in whole by the aforementioned machines, platforms, devices, or related systems (including computer, robotic, and autonomous systems). The components of the illustrative devices, systems, and methods employed may be implemented in various examples by digital electronic circuitry, analog electronic circuitry, or in computer hardware, firmware, software, or combinations of them. These components may be implemented, for example, as a computing program product such as a computing program, program code, or computer instructions tangibly embodied in an information carrier or a machine-readable storage device, for execution by, or to control the operation of, a data processing apparatus such as a programmable processor, a computer, or multiple computers.

A computing program may be written in any form of programming language, including compiled or interpreted languages, and it may be deployed in any form, including as a stand-alone program or as a module, component, subroutine, or other unit suitable for use in a computing environment. Also, functional programs, codes, and code segments for accomplishing the techniques described herein may be easily construed as within the scope of the present disclosure by programmers skilled in the art.

Method steps associated with the illustrative embodiments may be performed by processing circuitry executing a computing program, code, or instructions to perform operations or functions (e.g., by operating on input data and/or generating an output). Further, such operations or functions may be embodied by a machine-readable medium, which is capable of storing instructions for execution by processing circuitry (including the specific processing unit examples discussed herein), such that the instructions, when executed by the processing circuitry, cause the processing circuitry to perform any one or more of the methodologies described herein.

Additional examples of the presently described embodiments include the following non-limiting implementations. Each of the following non-limiting examples may stand on its own or may be combined in any permutation or combination with any one or more of the other examples provided below or throughout the present disclosure.

In broad strokes, telemetry management techniques are used to configure monitoring chiplets and the chiplet connectors (e.g., universal chiplet interconnect express (UCIe) connectors) state (e.g., thermal state, efficiency, performance, etc.) at different levels and propagate back that information to the software stack to perform more advanced resource management policies. More specifically, the disclosed telemetry management techniques include configuring telemetry management circuitry to perform advanced monitoring and telemetry (AMT) functions (e.g., at an IO hub as well as one or more chiplets) to provide interoperability and consistent telemetry schemes in a chiplet-based architecture (e.g., SoC). The telemetry management circuitry detects a communication flow for an application function that is associated with an application executing on at least one of the SoC's hardware resources. The telemetry management circuitry further retrieves a telemetry configuration based on the communication flow, where the telemetry configuration identifies at least one metric. The telemetry management circuitry executes a trace on the at least one metric to obtain metrics results and performs a telemetry action based on the metrics results.

Example 1 is processing circuitry, comprising compute circuitry, the compute circuitry comprising hardware resources configured to perform compute operations in a computing platform, and telemetry management circuitry configured to detect a communication flow for an application function, the application function associated with an application executing on at least one of the hardware resources; retrieve a telemetry configuration based on the communication flow, the telemetry configuration identifying at least one metric; execute a trace on the at least one metric to obtain metrics results; and perform a telemetry action based on the metrics results.

In Example 2, the subject matter of Example 1 includes subject matter such as the telemetry management circuitry is configured to detect an incompatibility between a metrics format of the at least one metric and a common metrics format associated with the computing platform.

In Example 3A, the subject matter of Example 2 includes subject matter such as the telemetry management circuitry is configured to apply a telemetry harmonization function to the at least one metric based on the incompatibility, wherein applying the telemetry harmonization function transforms the at least one metric to the common metrics format.

In Example 3B, the subject matter of Example 3A includes subject matter such as the telemetry management circuitry retrieves the telemetry harmonization function from a metric transformation library (MTL). In another example, the transformation is based on a transformation function (TF) that converts multiple common metrics (e.g., metrics defined according to a first metrics-related protocol or a first configuration) to vendor-specific metrics (e.g., metrics defined according to a second metrics-related protocol or configured by a vendor) (or vice versa).

In Example 3C, the subject matter of Example 3B includes subject matter such as the transformation equation can be as follows: (CommonMetric1, . . . , CommonMetricN)=TF(VendorMetric1, . . . , VendorMetricM). In another example, the common metrics or vendor-specific metrics can include data structures (e.g., one or more matrices) of related/associated metrics.

In Example 3D, the subject matter of Example 3C includes subject matter such as the TF calculates (or derives) a new metric.

In Example 3E, the subject matter of Example 3D includes subject matter such as the telemetry harmonization logic 226 determines a metric is a non-common metric (e.g., the metric is not defined by the first metrics-related protocol or the second metrics-related protocol).

In Example 3F, the subject matter of Example 3E includes subject matter such as the telemetry harmonization logic 226 calculates a new metric that is equivalent to the common metric, and updates its metric configuration (e.g., the newly calculated metric is inserted into the telemetry harmonization logic 226).

In Example 3G, the subject matter of Example 3F includes subject matter such as the harmonization function itself (e.g., the TF) is a calculation derived from several telemetry metrics that, in this case, are not part of the common metric.

In Example 4, the subject matter of Examples 1-3 includes subject matter such as the hardware resources comprise a plurality of chiplets, and wherein the telemetry management circuitry is configured to discover a plurality of metrics available at the plurality of chiplets, the plurality of metrics comprising the at least one metric.

In Example 5, the subject matter of Example 4 includes subject matter such as the telemetry management circuitry is configured to access the plurality of chiplets via one or more telemetry hardware application programming interfaces (APIs) to discover the plurality of metrics.

In Example 6, the subject matter of Example 5 includes subject matter such as to access the plurality of chiplets, the telemetry management circuitry is configured to access a chiplet telemetry monitoring unit (CTMU) in each chiplet of the plurality of chiplets via the one or more telemetry hardware APIs.

In Example 7, the subject matter of Example 6 includes subject matter such as the telemetry management circuitry is configured to retrieve the plurality of metrics via one or more Universal Chiplet Interconnect Express (UCIe) interfaces associated with the plurality of chiplets.

In Example 8, the subject matter of Examples 1-7 includes subject matter such as the telemetry management circuitry is configured to parse the telemetry configuration to obtain a rule, the rule specifying the telemetry action.

In Example 9, the subject matter of Example 8 includes subject matter such as the telemetry management circuitry is configured to detect the rule specifies the telemetry action as a Boolean operation on the at least one metric; and execute the Boolean operation to obtain the metrics results.

In Example 10, the subject matter of Examples 8-9 includes subject matter such as the telemetry management circuitry is configured to parse the telemetry configuration to further obtain a frequency; and perform the telemetry action based on the frequency.

In Example 11, the subject matter of Examples 1-IO includes subject matter such as to perform the telemetry action, the telemetry management circuitry is configured to perform a callback to a software stack associated with the application.

In Example 12, the subject matter of Examples 1-11 includes subject matter such as to perform the telemetry action, the telemetry management circuitry is configured to encode a notification with the metrics result for transmission to a management circuit associated with the executing of the application.

In Example 13, the subject matter of Examples 1-12 includes subject matter such as to execute the trace on the at least one metric, the telemetry management circuitry is configured to access one or more sensors of a Universal Chiplet Interconnect Express (UCIe) interposer circuit of the compute circuitry to obtain at least one of the metrics results.

In Example 14, the subject matter of Example 13 includes subject matter such as the hardware resources comprise a plurality of chiplets, wherein the UCIe interposer circuit comprises a plurality of UCIe interfaces associated with the plurality of chiplets, and wherein the telemetry management circuitry is configured to: execute the trace on the at least one metric using one or more of the plurality of UCIe interfaces; and map the metrics results to one or more of a plurality of process address space IDs (PASIDs) corresponding to the plurality of UCIe interfaces.

In Example 15, the subject matter of Examples 13-14 includes subject matter such as the UCIe interposer circuit comprises a second telemetry management circuitry, and wherein the telemetry management circuitry is configured to: retrieve the at least one of the metrics results from the second telemetry management circuitry.

In Example 16, the subject matter of Examples 1-15 includes subject matter such as the processing circuitry is a multi-chiplet package, wherein the compute circuitry includes at least one processor chiplet, and wherein the telemetry management circuitry includes a chiplet separate from the at least one processor chiplet.

Example 17 is a machine-readable medium including instructions, which when executed by processing circuitry, configures the processing circuitry according to any of Examples 1 to 16.

Example 18 is a method for telemetry monitoring, comprising operations to configure the processing circuitry according to any of Examples 1 to 16.

Example 19 is a method for telemetry monitoring, comprising detecting a communication flow for an application function, the application function associated with an application executing on at least one hardware resource of hardware resources; retrieving a telemetry configuration based on the communication flow, the telemetry configuration identifying at least one metric; executing a trace on the at least one metric to obtain metrics results; and performing a telemetry action based on the metrics results.

In Example 20, the subject matter of Example 19 includes detecting an incompatibility between a metrics format of the at least one metric and a common metrics format associated with the computing platform.

In Example 21, the subject matter of Example 20 includes applying a telemetry harmonization function to the at least one metric based on the incompatibility, wherein applying the telemetry harmonization function transforms the at least one metric to the common metrics format.

In Example 22, the subject matter of Examples 19-21 includes subject matter such as the hardware resources comprise a plurality of chiplets, and the method comprising discovering a plurality of metrics available at the plurality of chiplets, the plurality of metrics comprising the at least one metric.

In Example 23, the subject matter of Example 22 includes accessing the plurality of chiplets via one or more telemetry hardware application programming interfaces (APIs) to discover the plurality of metrics.

In Example 24, the subject matter of Example 23 includes subject matter such as accessing the plurality of chiplets comprises accessing a chiplet telemetry monitoring unit (CTMU) in each chiplet of the plurality of chiplets via the one or more telemetry hardware APIs.

In Example 25, the subject matter of Example 24 includes retrieving the plurality of metrics via one or more Universal Chiplet Interconnect Express (UCIe) interfaces associated with the plurality of chiplets.

In Example 26, the subject matter of Examples 19-25 includes parsing the telemetry configuration to obtain a rule, the rule specifying the telemetry action.

In Example 27, the subject matter of Example 26 includes detecting the rule specifies the telemetry action as a Boolean operation on the at least one metric; and executing the Boolean operation to obtain the metrics results.

In Example 28, the subject matter of Examples 26-27 includes parsing the telemetry configuration to further obtain a frequency; and performing the telemetry action based on the frequency.

In Example 29, the subject matter of Examples 19-28 includes subject matter such as performing the telemetry action comprises: performing a callback to a software stack associated with the application.

In Example 30, the subject matter of Examples 19-29 includes subject matter such as performing the telemetry action comprises: encoding a notification with the metrics result for transmission to a management circuit associated with the executing of the application.

In Example 31, the subject matter of Examples 19-30 includes subject matter such as executing the trace on the at least one metric comprises: accessing one or more sensors of a Universal Chiplet Interconnect Express (UCIe) interposer circuit to obtain at least one of the metrics results.

In Example 32, the subject matter of Example 31 includes subject matter such as the hardware resources comprise a plurality of chiplets, wherein the UCIe interposer circuit comprises a plurality of UCIe interfaces associated with the plurality of chiplets, and the method comprising: executing the trace on the at least one metric using one or more of the plurality of UCIe interfaces; and mapping the metrics results to one or more of a plurality of process address space IDs (PASIDs) corresponding to the plurality of UCIe interfaces.

In Example 33, the subject matter of Examples 31-32 includes subject matter such as the UCIe interposer circuit comprises a second telemetry management circuitry, and the method comprising: retrieving the at least one of the metrics results from the second telemetry management circuitry.

Example 34 is a machine-readable medium including instruction that, when executed by processing circuitry, causes the processing circuitry to perform any method of Examples 19-33.

Example 35 is a system comprising means to perform any method of Examples 19-33.

Example 36 is a machine-readable media including instructions for telemetry monitoring, the instructions, when executed by processing circuitry of a chiplet, cause the processing circuitry to perform operations comprising detecting a communication flow for an application function, the application function associated with an application executing on at least one hardware resource of hardware resources; retrieving a telemetry configuration based on the communication flow, the telemetry configuration identifying at least one metric; executing a trace on the at least one metric to obtain metrics results; and performing a telemetry action based on the metrics results.

In Example 37, the subject matter of Example 36 includes subject matter such as detecting an incompatibility between a metrics format of the at least one metric and a common metrics format associated with the computing platform.

In Example 38, the subject matter of Example 37 includes subject matter such as applying a telemetry harmonization function to the at least one metric based on the incompatibility, wherein applying the telemetry harmonization function transforms the at least one metric to the common metrics format.

In Example 39, the subject matter of Examples 36-38 includes subject matter such as the hardware resources comprise a plurality of chiplets, and the operations comprising: discovering a plurality of metrics available at the plurality of chiplets, the plurality of metrics comprising the at least one metric.

In Example 40, the subject matter of Example 39 includes subject matter such as accessing the plurality of chiplets via one or more telemetry hardware application programming interfaces (APIs) to discover the plurality of metrics.

In Example 41, the subject matter of Example 40 includes subject matter such as accessing the plurality of chiplets comprises accessing a chiplet telemetry monitoring unit (CTMU) in each chiplet of the plurality of chiplets via the one or more telemetry hardware APIs.

In Example 42, the subject matter of Example 41 includes subject matter such as retrieving the plurality of metrics via one or more Universal Chiplet Interconnect Express (UCIe) interfaces associated with the plurality of chiplets.

In Example 43, the subject matter of Examples 36-42 includes subject matter such as parsing the telemetry configuration to obtain a rule, the rule specifying the telemetry action.

In Example 44, the subject matter of Example 43 includes subject matter such as detecting the rule specifies the telemetry action as a Boolean operation on the at least one metric; and executing the Boolean operation to obtain the metrics results.

In Example 45, the subject matter of Examples 43-44 includes subject matter such as parsing the telemetry configuration to further obtain a frequency; and performing the telemetry action based on the frequency.

In Example 46, the subject matter of Examples 36-45 includes subject matter such as performing the telemetry action comprises: performing a callback to a software stack associated with the application.

In Example 47, the subject matter of Examples 36-46 includes subject matter such as performing the telemetry action comprises encoding a notification with the metrics result for transmission to a management circuit associated with the executing of the application.

In Example 48, the subject matter of Examples 36-47 includes subject matter such as executing the trace on the at least one metric comprises accessing one or more sensors of a Universal Chiplet Interconnect Express (UCIe) interposer circuit to obtain at least one of the metrics results.

In Example 49, the subject matter of Example 48 includes subject matter such as the hardware resources comprise a plurality of chiplets, wherein the UCIe interposer circuit comprises a plurality of UCIe interfaces associated with the plurality of chiplets, and the operations comprising: executing the trace on the at least one metric using one or more of the plurality of UCIe interfaces; and mapping the metrics results to one or more of a plurality of process address space IDs (PASIDs) corresponding to the plurality of UCIe interfaces.

In Example 50, the subject matter of Examples 48-49 includes subject matter such as the UCIe interposer circuit comprises telemetry management circuitry and the operations comprising retrieving the at least one of the metrics results from the second telemetry management circuitry.

Example 51 is a system for telemetry monitoring, comprising: means for detecting a communication flow for an application function, the application function associated with an application executing on at least one hardware resource of hardware resources; means for retrieving a telemetry configuration based on the communication flow, the telemetry configuration identifying at least one metric; means for executing a trace on the at least one metric to obtain metrics results; and means for performing a telemetry action based on the metrics results.

In Example 52, the subject matter of Example 51 includes means for detecting an incompatibility between a metrics format of the at least one metric and a common metrics format associated with the computing platform.

In Example 53, the subject matter of Example 52 includes means for applying a telemetry harmonization function to the at least one metric based on the incompatibility, wherein applying the telemetry harmonization function transforms the at least one metric to the common metrics format.

In Example 54, the subject matter of Examples 51-53 includes subject matter such as the hardware resources comprise a plurality of chiplets, and the system comprising means for discovering a plurality of metrics available at the plurality of chiplets, the plurality of metrics comprising the at least one metric.

In Example 55, the subject matter of Example 54 includes means for accessing the plurality of chiplets via one or more telemetry hardware application programming interfaces (APIs) to discover the plurality of metrics.

In Example 56, the subject matter of Example 55 includes subject matter such as accessing the plurality of chiplets comprises means for accessing a chiplet telemetry monitoring unit (CTMU) in each chiplet of the plurality of chiplets via the one or more telemetry hardware APIs.

In Example 57, the subject matter of Example 56 includes means for retrieving the plurality of metrics via one or more Universal Chiplet Interconnect Express (UCIe) interfaces associated with the plurality of chiplets.

In Example 58, the subject matter of Examples 51-57 includes means for parsing the telemetry configuration to obtain a rule, the rule specifying the telemetry action.

In Example 59, the subject matter of Example 58 includes means for detecting the rule specifies the telemetry action as a Boolean operation on the at least one metric; and means for executing the Boolean operation to obtain the metrics results.

In Example 60, the subject matter of Examples 58-59 includes means for parsing the telemetry configuration to further obtain a frequency; and means for performing the telemetry action based on the frequency.

In Example 61, the subject matter of Examples 51-60 includes subject matter such as the means for performing the telemetry action comprises means for performing a callback to a software stack associated with the application.

In Example 62, the subject matter of Examples 51-61 includes subject matter such as the means for performing the telemetry action comprises: means for encoding a notification with the metrics result for transmission to a management circuit associated with the executing of the application.

In Example 63, the subject matter of Examples 51-62 includes subject matter such as the means for executing the trace on the at least one metric comprises means for accessing one or more sensors of a Universal Chiplet Interconnect Express (UCIe) interposer circuit to obtain at least one of the metrics results.

In Example 64, the subject matter of Example 63 includes subject matter such as the hardware resources comprise a plurality of chiplets, wherein the UCIe interposer circuit comprises a plurality of UCIe interfaces associated with the plurality of chiplets, and the system comprising: means for executing the trace on the at least one metric using one or more of the plurality of UCIe interfaces; and means for mapping the metrics results to one or more of a plurality of process address space IDs (PASIDs) corresponding to the plurality of UCIe interfaces.

In Example 65, the subject matter of Examples 63-64 includes subject matter such as the UCIe interposer circuit comprises telemetry management circuitry, and the system comprising means for retrieving the at least one of the metrics results from the second telemetry management circuitry.

Example 66 is at least one machine-readable medium including instructions that, when executed by processing circuitry, cause the processing circuitry to perform operations to implement any of Examples 1-65.

Example 67 is an apparatus comprising means to implement any of Examples 1-65.

Example 68 is a system to implement any of Examples 1-65.

Example 69 is a method to implement any of Examples 1-65.

What is claimed is:

1. Processing circuitry, comprising:
compute circuitry, the compute circuitry including hardware resources to perform compute operations in a computing platform; and
telemetry management circuitry to:
detect a communication flow for an application function associated with a process executing on at least one of the hardware resources;
retrieve a telemetry configuration based on the communication flow, the telemetry configuration identifying at least one metric of a metric type for the process executing on the at least one of the hardware resources;
execute a trace on the at least one metric to obtain metrics results; and
perform a telemetry action based on the metrics results.

2. The processing circuitry of claim 1, wherein the telemetry management circuitry is to:
detect an incompatibility between a metrics format of the at least one metric and a standard metrics format associated with the computing platform.

3. The processing circuitry of claim 2, wherein the telemetry management circuitry is to:
apply a telemetry harmonization function to the at least one metric based on the incompatibility, wherein applying the telemetry harmonization function transforms the at least one metric to the standard metrics format.

4. The processing circuitry of claim 1, wherein the processing circuitry is a multi-chiplet package, wherein the hardware resources of the compute circuitry include a plurality of chiplets, wherein the telemetry management circuitry includes a chiplet separate from the plurality of chiplets, and wherein the chiplet of the telemetry management circuitry is to:
discover a plurality of metrics available at the plurality of chiplets, the plurality of metrics comprising the at least one metric.

5. The processing circuitry of claim 4, wherein the telemetry management circuitry is to:
access the plurality of chiplets via one or more telemetry hardware application programming interfaces (APIs) to discover the plurality of metrics.

6. The processing circuitry of claim 5, wherein to access the plurality of chiplets, the telemetry management circuitry is to:
access a chiplet telemetry monitoring unit (CTMU) in each chiplet of the plurality of chiplets via the one or more telemetry hardware APIs.

7. The processing circuitry of claim 6, wherein the telemetry management circuitry is to:
retrieve the plurality of metrics via one or more Universal Chiplet Interconnect Express (UCIe) interfaces associated with the plurality of chiplets.

8. The processing circuitry of claim 7, wherein the telemetry management circuitry is to:
parse the telemetry configuration to obtain a rule, the rule specifying the telemetry action.

9. The processing circuitry of claim 8, wherein the rule specifies the telemetry action as a Boolean operation on the at least one metric, and wherein the telemetry management circuitry is to:
execute the Boolean operation to obtain the metrics results.

10. The processing circuitry of claim 8, wherein the telemetry management circuitry is to:
parse the telemetry configuration to obtain a frequency that a particular action is being performed; and
perform the telemetry action based on the frequency.

11. The processing circuitry of claim 1, wherein to perform the telemetry action, the telemetry management circuitry is to:
perform a callback to a software stack associated with the process; and
encode a notification with the metrics results for transmission to a management software stack associated with the executing of the process.

12. The processing circuitry of claim 1, wherein to execute the trace on the at least one metric, the telemetry management circuitry is to:
access one or more sensors of a Universal Chiplet Interconnect Express (UCIe) interposer circuit of the compute circuitry to obtain at least one of the metrics results.

13. The processing circuitry of claim 12, wherein the hardware resources comprise a plurality of chiplets, wherein the UCIe interposer circuit comprises a plurality of UCIe interfaces associated with the plurality of chiplets, and wherein the telemetry management circuitry is to:
execute the trace on the at least one metric, using one or more of the plurality of UCIe interfaces; and
map the metrics results to one or more of a plurality of process address space IDs (PASIDs) corresponding to the plurality of UCIe interfaces.

14. The processing circuitry of claim 12, wherein the UCIe interposer circuit comprises a second telemetry management circuitry, and wherein the telemetry management circuitry is to:
retrieve the at least one of the metrics results from the second telemetry management circuitry.

15. An apparatus comprising:
means for performing compute operations in a computing platform;
means for detecting a communication flow for an application function, the application function associated with a process executing on at least one of hardware resources of the computing platform;
means for retrieving a telemetry configuration based on the communication flow, the telemetry configuration identifying at least one metric of a metric type for the process executing on the at least one of the hardware resources;
means for executing a trace on the at least one metric to obtain metrics results; and
means for perform a telemetry action based on the metrics results.

16. The apparatus of claim 15, comprising:
means for detecting an incompatibility between a metrics format of the at least one metric and a standard metrics format associated with the computing platform; and
means for applying a telemetry harmonization function to the at least one metric based on the incompatibility, wherein applying the telemetry harmonization function transforms the at least one metric to the standard metrics format.

17. At least one non-transitory machine-readable medium comprising instructions stored thereon, which, when executed by telemetry management circuitry, causes the telemetry management circuitry to:
detect a communication flow for an application function, the application function associated with a process executing on at least one of hardware resources of a computing platform;
retrieve a telemetry configuration based on the communication flow, the telemetry configuration identifying at least one metric of a metric type for the process executing on the at least one of the hardware resources;
execute a trace on the at least one metric to obtain metrics results; and
perform a telemetry action based on the metrics results.

18. The at least one non-transitory machine-readable medium of claim 17, wherein execution of the instructions causes the telemetry management circuitry to:
detect an incompatibility between a metrics format of the at least one metric and a standard metrics format associated with the computing platform; and
apply a telemetry harmonization function to the at least one metric based on the incompatibility, wherein applying the telemetry harmonization function transforms the at least one metric to the standard metrics format.

19. The at least one non-transitory machine-readable medium of claim 18, wherein execution of the instructions causes the telemetry management circuitry to:
discover a plurality of metrics available at a plurality of chiplets of the at least one of the hardware resources, the plurality of metrics comprising the at least one metric.

20. The at least one non-transitory machine-readable medium of claim 17, wherein execution of the instructions causes the telemetry management circuitry to:
perform a callback to a software stack associated with the process; and
encode a notification with the metrics results for transmission to a management software stack associated with the executing of the process.
